(19) United States
(12) Patent Application Publication
(10) Pub. No.: US 2011/0114069 A1
(43) Pub. Date: May 19, 2011

(54) APPARATUS, SYSTEM AND METHOD FOR OPERATING AN OXYGEN-ENRICHED AMMONIA-FUELED SPARK IGNITION ENGINE

(76) Inventors: Shawn Grannell, Ann Arbor, MI (US); Donald E. Gillespie, Ann Arbor, MI (US)

(21) Appl. No.: 12/947,137

(22) Filed: Nov. 16, 2010

Related U.S. Application Data
(60) Provisional application No. 61/261,440, filed on Nov. 16, 2009.

(51) Int. Cl. F02B 23/00

(52) U.S. Cl. 123/585

(57) ABSTRACT

Described herein are various embodiments of an apparatus, system and method for operating an oxygen-enriched ammonia-fueled spark ignition engine. According to one illustrative embodiment, a method for operating an oxygen-enriched ammonia-fueled spark ignition engine includes fueling the engine with a mixture of ammonia and auxiliary oxygen within a first engine load range between zero and an engine load associated with a target combustion condition selected from the group consisting of rough limit, MBT knock limit, and any of various conditions between the rough limit and MBT knock limit. Within the first engine load range, the amounts of ammonia and auxiliary oxygen consumed per cycle increase as the load increases. The method further includes fueling the engine on a mixture of ammonia, auxiliary oxygen, and air within a second engine load range between the engine loads associated with the selected target combustion condition and the maximum engine load.

### REFERENCE TO RELATED APPLICATION

This application claims priority from U.S. Provisional Patent Application Ser. No. 61/261,440, filed Nov. 16, 2009, the entire content of which is incorporated herein by reference.

### FIELD OF THE INVENTION

The present disclosure relates to the operation of an internal combustion engine capable of running on ammonia as the only fuel, and more particularly to the operation of a spark ignition engine capable of running on ammonia, air, and an oxidizing combustion promoter, specifically oxygen.

### BACKGROUND OF THE INVENTION

Due at least in part to high crude oil prices, environmental concerns, and future fuel availability, many internal combustion engine designers have looked to replace crude oil fossil fuels, e.g., gasoline and diesel, with so-called alternative fuels for powering internal combustions engines. Desirably, by replacing fossil fuels with alternative fuels, the cost of fueling internal combustion engines is decreased, harmful environmental pollutants are decreased, and/or the future availability of fuels is increased.

Ammonia is one such alternative fuel capable of replacing or at least partially replacing crude oil fossil fuels. Ammonia (NH₃) is widely used in household cleaning supplies and agricultural fertilizer. Unlike hydrogen, ammonia need not be stored under extreme pressures to maintain the ammonia at a usable energy density. Ammonia is currently manufactured and transported in mass quantities. Presently, ammonia is at least the fourth most transported commodity in the United States and costs less than gasoline, e.g., the price of ammonia is less than that of gasoline per unit of energy. Ammonia can be stored indefinitely as a liquid at pressures nearly the same as those of propane. Accordingly, ammonia can be transported via currently available high pressure pipelines. Ammonia can be made from energy sources, such as nuclear power and wind, which are characterized as having a high power/land surface area density, in some cases, these energy sources have a power/land area density that is more than 1000 times greater than the ˜1 kW/acre average annual energy production rate which is typical for the biofuels. Therefore, the manufacture, handling and distribution of ammonia are more feasible than some of the other alternative fuels.

The use of ammonia as an energy carrier makes possible the indirect use of nuclear fission or eventually fusion, in mobile applications where direct use would be impractical. The storage, distribution and use of energy obtained from intermittently active, renewable sources such as wind and solar can also be addressed by using ammonia as an energy carrier.

Ammonia is an attractive alternative fuel because it can be made from air and water, using nuclear power or renewable energy sources such as wind, hydroelectric, geothermal, and solar. Ammonia can be stored as an anhydrous liquid at 300 Kelvin and approximately 10 bars pressure. Ammonia has reasonable energy/volume and energy/mass densities, which, although lower as those of gasoline by factors of 2.6 and 2.3, respectively, are still well within reach of practical use in automobiles and other machinery as a principal energy carrier, unlike batteries, which, when used in automobiles and other vehicles, can be prohibitively expensive and can weigh almost as much as the rest of the vehicle for a driving range which is currently typical for hydrocarbon-fueled vehicles, for example automobiles which are expected to have a range of about 300 miles between refueling or recharging.

Because ammonia does not contain carbon, the combustion of ammonia does not result in greenhouse gas, CO, CO₂ or carbon particulate pollution emissions into the environment. More specifically, the byproducts of complete combustion of ammonia are relatively innocuous pure water and nitrogen. Therefore, in some practical instances, little to no environmentally dangerous emissions need be generated in the manufacture and combustion of ammonia.

Many ammonia-fueled internal combustion engines known in the art, however, suffer from one or more shortcomings. For example, ammonia has a slower flame speed, is more difficult to ignite, has a higher auto ignition temperature, and is less flammable than gasoline and many other alternative fuels, such as hydrogen. Some internal combustion engines use high compression ratios and supercharging to improve the combustibility of ammonia at high engine loads and a limited range of crankshaft revolutions per minute (RPM). However, at low engine loads, such as during idling of the engine, or at high RPM, the combustibility of ammonia is incomplete and the performance of the engine suffers.

Some ammonia-fueled internal combustion engines known in the art use a combustion promoter to promote the combustion of the ammonia. These engines do not use oxygen as a combustion promoter, which permits operation on pure ammonia as the only fuel for all loads, including loads corresponding to zero crankshaft torque at any given speed (idle), and at high RPM.

Aircraft and rocket engines fueled by oxygen and ammonia are known to the art. However, these engines obtain their oxygen from a storage tank, and these engines do not obtain pure oxygen by extracting it from air. The separation work required to obtain pure oxygen from air, is too large to permit an engine to operate feasibly with pure oxygen as the sole oxidizer, when the oxygen is obtained from an air separator which is powered by the engine. Furthermore, a stoichiometric mixture of pure oxygen and ammonia has about twice the energy per total moles of exhaust product, as does a stoichiometric mixture of air (of 21% oxygen content by volume) and ammonia. Stoichiometric operation with pure oxygen as the sole oxidizer is thus expected to present severe problems concerning knock, excessive exhaust gas temperatures, efficiency loss, chemical dissociation, and excessive transfer of heat to the combustion chamber boundaries when ammonia is combusted with pure oxygen in an internal combustion engine.

The inventors' previous U.S. Pat. No. 7,574,993 describes the use of ammonia with a combustion promoter. In that case the combustion promoter was a fuel which is more reactive than ammonia when either fuel is burned in air. It was shown that an engine could be operated successfully, within prescribed limits, on ammonia and another fuel. Both the ammonia and the other fuel were reducing agents, and the oxidizing agent was air, which is approximately 21% oxygen by volume. Stoichiometry was maintained by admitting sufficient air into the engine as required for complete combustion of the ammonia and the other fuel. The properties of ammonia and air are such that, when the load of an engine is increased by the addition of more ammonia and air to a given operating point while maintaining stoichiometric combustion, the knock properties, roughness properties, and spark timing properties remain essentially unchanged for a substantial portion of the load range. Ammonia addition with air has a very nearly neutral effect on combustion characteristics, and thus a given combustion condition corresponds to a substantially constant per-cycle requirement of the combustion promoter.

Based on the foregoing, there is a need for a spark ignited internal combustion engine capable of stoichiometric operation on ammonia, air, and auxiliary oxygen throughout the entire range of engine loads and RPM.

### SUMMARY OF THE INVENTION

This invention broadly relates to the use of an oxidizing agent to promote the combustion of ammonia, particularly in spark ignition internal combustion engines. In the preferred embodiments, the oxidizing combustion promoter has reactivity with ammonia which is higher than the reactivity of air with ammonia. Stoichiometry is maintained by admitting sufficient ammonia into the engine as required for complete consumption of the air and the oxidizer. Ammonia is the only reducing agent, and the only fuel. It was discovered that increasing the load of an engine by the addition of more ammonia and air to a given operating point, while maintaining stoichiometric combustion, has a very nearly neutral effect on combustion characteristics, and thus a given combustion condition corresponds to a substantially constant per-cycle requirement of the oxidizing combustion promoter.

In the preferred embodiment the oxidizing combustion promoter is oxygen. It was discovered that the reactivity of pure oxygen, or a gas mixture consisting substantially of oxygen, is high enough to promote the combustion of ammonia. A comparatively small auxiliary oxygen input is sufficient to promote the combustion of an overall stoichiometric mixture which consists otherwise mostly of ammonia and air for most operating points. Oxygen is unique among the combustion promoters in that it can be obtained from air, using one of the various types of air separators, thus obviating the need for a large, high pressure container of a combustion promoter, although the use of a high pressure tank of compressed oxygen gas is still permitted. Oxygen also obviates the need to obtain a combustion promoter by decomposing a portion of the ammonia into hydrogen and nitrogen on a heated catalyst.

It was further determined that air-breathing internal combustion engines require only a relatively small quantity of additional oxygen to effectively burn ammonia. As such, operation of a normally aspirated engine on ammonia is feasible, with an auxiliary oxygen input sufficient to promote the combustion of a mixture consisting otherwise of mostly ammonia and air for most operating points. Nonetheless, the engineering requirements of the auxiliary oxygen source can be reduced by downsizing and supercharging the engine. The high knock resistance of ammonia permits operation in portions of a highly supercharged load regime, which are normally forbidden to other fuels, such as gasoline. Given these variables, the present invention may include an intake system adapted to feed an existing engine, and/or combinations of intake systems and combustion chambers, with or without supercharging.

By downsizing and supercharging, the required auxiliary oxygen input can be made an even smaller fraction of the total charge for a given power output, and the power required by an oxygen separator can be made an even smaller fraction of the engine's total average energy budget. In the limit of having an arbitrarily small engine, operating at arbitrarily high average brake mean effective pressures, the power needed to run an oxygen separator can be made an arbitrarily small fraction of the engine's total average energy budget.

The use of an auxiliary oxygen input thus permits engine operation on ammonia as the only fuel. Some of the advantages gained by using oxygen as a combustion promoter for ammonia include: Oxygen totally eliminates dependence on gasoline or other fuels as combustion promoters for ammonia. It simplifies the refueling process and distribution of fuel because ammonia is the only fuel required. It eliminates certain emissions, such as unburned hydrocarbons and carbon monoxide, and carbon dioxide, which strictly originate from the use of carbon-containing fuels. The ammonia, oxygen and air can be delivered to the engine as gases, thus obviating the need to run substantially rich at startup. Substantially rich operation at startup is usually required when a liquid fuel, such as gasoline, is metered into the engine in liquid form. It eliminates components which must be warmed up before the combustion promoter source becomes operational, as in the case of the catalytic cracker which decomposes a portion of the ammonia into hydrogen and nitrogen.

### BRIEF DESCRIPTION OF THE DRAWINGS

In order that the advantages of the disclosed apparatus, system and method will be readily understood, a more particular description of the apparatus, system and method briefly described above will be rendered by reference to specific embodiments that are illustrated in the appended drawings. Understanding that these drawings depict only exemplary embodiments of the disclosed subject matter and are not therefore to be considered to limit the scope of the disclosed subject matter, the subject matter of the present application will be described and explained with additional specificity and detail through the use of the accompanying drawings, in which:

FIG. 1 is a schematic diagram of an engine system according to one representative embodiment;

FIG. 2 is an operating map for operation of the engine system of FIG. 1 at a given compression ratio and engine RPM according to one representative embodiment;

FIG. 3 is a graph of the mass fraction burn curve for various engine operating conditions as a function of the crank angle and instantaneous cylinder compression;

FIG. 4 is an operating map for operation of the engine system of FIG. 1 at the rough limit and a given compression ratio for varying engine RPM; and

FIG. 5 is an operating map for operation of the engine system of FIG. 1 at varying compression ratios.

### DETAILED DESCRIPTION OF THE INVENTION

Reference throughout this specification to features, advantages, or similar language does not imply that all of the features and advantages that may be realized with the apparatus, system and method of the present disclosure should be or are in any single embodiment of the disclosed apparatus, system and method. Rather, language referring to the features and advantages is understood to mean that a specific feature, advantage, or characteristic described in connection with an embodiment is included in at least one embodiment of the disclosed apparatus, system and method. Thus, discussion of the features and advantages, and similar language, throughout this specification may, but do not necessarily, refer to the same embodiment.

Furthermore, the described features, advantages, and characteristics of the disclosed apparatus, system and method may be combined in any suitable manner in one or more embodiments. One skilled in the relevant art will recognize that the apparatus, system and method may be practiced without one or more of the specific features or advantages of a particular embodiment. In other instances, additional features and advantages may be recognized in certain embodiments that may not be present in all embodiments of the disclosed apparatus, system and method.

Reference throughout this specification to “one embodiment,” “an embodiment,” or similar language means that a particular feature, structure, or characteristic described in connection with the embodiment is included in at least one embodiment of the apparatus, system or method disclosed in the application. Thus, appearances of the phrases “in one embodiment,” “in an embodiment,” and similar language throughout this specification may, but do not necessarily, all refer to the same embodiment.

Furthermore, the described features, structures, or characteristics of the apparatus, system and method disclosed herein may be combined in any suitable manner in one or more embodiments. In the following description, numerous specific details are provided to provide a thorough understanding of embodiments of the disclosed subject matter. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of disclosed subject matter.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Further, a module may include a component or group of components operatively coupled to perform one or more specific functions.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

The subject matter of the present disclosure has been developed in response to the present state of the art, and in particular, in response to the problems and needs in the art that have not yet been fully solved by currently available internal combustion engines. Accordingly, described herein are embodiments of an apparatus, system and method for operating an oxygen-enriched ammonia-fueled spark ignition engine that overcome at least one of the above-discussed or other shortcomings in the art. For example, according to some embodiments, an apparatus, system and method of operating an oxygen-enriched ammonia-fueled spark ignition engine is disclosed that, among other things, allows operation on ammonia as the only fuel.

According to one representative embodiment, an oxygen-enriched ammonia-fueled spark ignition internal combustion engine includes an engine intake line that is coupled to at least one combustion chamber. The engine can further include an air intake system that is in air supplying communication with the engine intake line. Additionally, the engine includes an ammonia delivery system that includes an ammonia flow module and an ammonia source, for example a pressurized tank of liquid anhydrous ammonia, and an auxiliary oxygen flow module and an auxiliary oxygen source separate from the ammonia flow module and ammonia source. The ammonia and auxiliary oxygen flow modules may be operable to deliver ammonia and auxiliary oxygen into the engine intake line either upstream or downstream of an air flow module. The engine also includes an electronic control module that is operable to control the flow rates of ammonia and auxiliary oxygen into the engine intake line to achieve substantially stoichiometric combustion of air, ammonia and auxiliary oxygen in the combustion chamber for each cycle of the internal combustion engine. In some implementations, the ammonia source is an ammonia container and the auxiliary oxygen source is a pressure swing absorption unit that extracts an oxygen-rich gas mixture from air. In some implementations, the electronic control module is operable to control the flow rates of ammonia and auxiliary oxygen into the engine intake to operate the engine at a desired operational state between a rough limit and an MBT knock limit.

The rough limit is the minimum auxiliary oxygen input for which the coefficient of variation of the gross indicated mean effective pressure (COV(IMEP_{g})) remains at or below a particular chosen value. In prior publications, the coefficient of variation of the net indicated mean effective pressure (COV(IMEPₙ) was used to define roughness. However, when oxygen is used as a combustion promoter, the transition between the first and second load ranges for the rough limit (the rough-limit air cut-in point) occurs substantially below idle, near net indicated mean effective pressure=0, where the COV(IMEPₙ) is undefined. At high load, the COV(IMEPₙ) and COV(IMEP_{g}) are very nearly the same. Excessive roughness is defined as operation with a COV(IMEP_{g}) in excess of the chosen value. In some instances this chosen value is 3%, although it is anticipated that a value as high as 5% or higher may be chosen. For operation near the rough limit, the use of more auxiliary oxygen has the effect of lowering the COV(IMEP_{g}). However, there is little reduction in the auxiliary oxygen input per cycle for operation at COV(IMEP_{g}) in excess of 3%, and a significant efficiency loss generally occurs if the COV(IMEP_{g}) is allowed to exceed about 5-10%. By operating at the rough limit, the engineering requirements of the oxygen source are minimized. These requirements include the oxygen source's size, weight, power consumption, materials, and cost.

The MBT knock limit is the maximum auxiliary oxygen input for which maximum brake torque (MET) spark timing can be maintained without causing knock. The width of the region separating the rough limit and the MBT knock limit shrinks as the compression ratio is raised. Combustion promoters are characterized by a compression ratio at which the rough limit and MBT knock limit meet, and this compression ratio must not be exceeded. It is preferred to use a compression ratio for which the auxiliary oxygen input permitted at the MET knock limit is substantially higher than the auxiliary oxygen input required at the rough limit. If an engine is designed to use a constant compression ratio below the compression ratio at which the rough and MBT knock limits meet, then the auxiliary oxygen input at the MBT knock limit will be greater than the auxiliary oxygen input at the rough limit. It is preferred to use a compression ratio less than the compression ratio at which a prescribed auxiliary oxygen input per cycle, near the rough limit, becomes greater than the auxiliary oxygen input per cycle at the MBT knock limit, for any combination of load and RPM within the engine's range of operation.

It is common practice to have the spark occur near top center during cranking at startup to avoid kickback. Because the spark timing used during cranking at startup is generally retarded of MBT, operation with an auxiliary oxygen input greater than the rough limit may be required, and an auxiliary oxygen input greater than the MBT knock limit may be permitted, during cranking at startup to improve starting reliability. After starting, the use of auxiliary oxygen in excess of the rough limit but not exceeding the MBT knock limit may be continued during some portion of the warm-up period to provide additional assurance against misfire and/or to reduce the engine-out emissions of ammonia. The positions of the rough limit and MBT knock limit will also generally vary with engine temperatures. For both limits the auxiliary oxygen input will be somewhat higher when the engine is cold than when the engine is fully warmed up. Alternatively, after starting, the auxiliary oxygen input may be maintained as appropriate for operation at the rough limit during the engine warm-up period, and adjustments for the various engine temperatures may be included in the auxiliary oxygen and spark advance calibration maps for the rough limit. The various engine temperatures affecting the calibration maps include, but are not limited to, engine coolant temperature, oil temperature and intake temperature. Operation at the rough limit is preferred when the engine is fully warmed up.

The equation (1−X)N₂+(X)O₂+(4X/3)NH₃ describes a resultant stoichiometric intake mixture of air, auxiliary oxygen and ammonia, for which X is the oxygen fraction of the air and auxiliary oxygen portions of the intake mixture (hereafter referred to as the oxygen fraction). The inert fraction (1−X) is a mixture of mostly nitrogen with small amounts of argon, water vapor and other gases. If no auxiliary oxygen input is used, X=0.21 as the oxygen concentration of air is approximately 21% by volume and the remainder consists mostly of nitrogen. X=1 when the combustion promoter is 100% oxygen and air is completely excluded.

Rich operation is not desired because rich combustion produces leftover reducing agents such as hydrogen and ammonia which represent wasted fuel and which may not contribute substantially to the reactivity of the mixture. An engine fueled by an ammonia/air/auxiliary oxygen mixture can be run lean. However, the flammability constraint for lean operation at the rough limit can be understood to good approximation by counting the extra oxygen as part of the inert fraction. Lean operation can be effected, while holding the mixture flammability constant, by increasing the auxiliary oxygen input and decreasing the air input by equal volumes, while holding the ammonia input constant, thereby substituting a portion of the nitrogen or other inert gas with an equal volume of oxygen, which also leaves the adiabatic flame temperature and the ratio of specific heats essentially unchanged. More auxiliary oxygen is thus required for lean operation at the rough limit than for stoichiometric operation at the rough limit, for a given ammonia input. For operation at the rough limit at normally aspirated, wide open throttle (WOT), a transition from stoichiometric operation to 10% lean operation requires a near-doubling of the auxiliary oxygen input. Lean operation thus presents a significant disadvantage from the standpoint of seeking to minimize the engineering requirements of the auxiliary oxygen source.

Stoichiometric operation gives a good compromise between power density and efficiency, and it is also near the flame speed maximum for ammonia. In some instances the post-catalyst exhaust emissions clean-up point for ammonia also occurs at stoichiometric. The engine-out pollutants produced by an ammonia fueled engine can be made to cancel each other out on a catalyst when stoichiometric operation is used. The flammability and stoichiometry of the intake mixture are tuned by controlling the mass flows of ammonia and auxiliary oxygen for a given air mass flow. The flammability of a stoichiometric ammonia/air mixture, without additional oxygen, is generally inadequate for acceptable engine operation. Therefore an auxiliary oxygen input is required to tune the flammability upward as required at each operating point. The requirement for auxiliary oxygen is minimized for overall stoichiometric operation.

An engine may be calibrated for a rough limit, an MBT knock limit, or any of the various combustion conditions between a rough limit and an MBT knock limit, for example a constant auxiliary oxygen input per cycle for a given RPM. This engine calibration may be performed with dry air comprising approximately 21% oxygen by volume, and a combustion promoter comprising 100% oxygen. Air composition may vary principally because of varying moisture content, and at 100 kPa ambient pressure and 100° F., air may consist of anywhere between about 19.5% and 20.9% oxygen by volume. The auxiliary oxygen may have impurities because some of the methods used to extract an oxygen-rich gas mixture from air may pass most of the argon and a small portion of the nitrogen with the oxygen, and the resulting oxygen-rich gas mixture may typically contain between about 85% and 95% oxygen by volume.

Combustion promoter input corrections for moisture in the air and impurities in the auxiliary oxygen can be readily calculated to good approximation by assuming that a given operating point, once calibrated for air containing about 21% oxygen by volume and a combustion promoter containing 100% pure oxygen, will require the same oxygen fraction to maintain the same combustion properties in the second engine load region. Furthermore, the properties of the rough limit are such that, a combustion promoter input per cycle which is sufficient at idle, will be slightly more than sufficient at loads above idle at a given RPM, because, for all combustion promoters including oxygen, the combustion promoter input per cycle at the rough limit decreases slightly with increasing load under most conditions. The auxiliary oxygen input corrections for moisture at idle are small. Typically, the auxiliary oxygen input per cycle at the rough limit near idle would be increased by a factor of about 1.05 to 1.1 when the moisture content of the air increases from 0% relative humidity to 100% relative humidity, at 100° F. and 100 kPa ambient pressure.

The effect of impurities in the auxiliary oxygen can be readily understood by treating the oxygen-rich mixture as behaving like a mixture of air and pure oxygen, wherein the air-like portion has a neutral effect on the effectiveness as a combustion promoter. In one example, for a combustion promoter comprising 100 percent oxygen, all of the oxygen contributes to the oxygen-rich gas mixture's effectiveness as a combustion promoter. In another example, a combustion promoter comprising 80 percent oxygen by volume will behave like a mixture comprising 74.7 percent pure oxygen and 25.3 percent air (of 21 percent oxygen content) by volume. Therefore, when the combustion promoter contains 80 percent oxygen by volume, nearly all of the oxygen in the combustion promoter contributes to the oxygen-rich gas mixture's effectiveness as a combustion promoter. In yet another example, a combustion promoter comprising 50 percent oxygen by volume will behave like a mixture comprising 36.7 percent pure oxygen and 63.3 percent air (of 21% oxygen content) by volume. Therefore, when the combustion promoter contains 50% oxygen by volume, a large fraction of the oxygen in the combustion promoter does not contribute to the oxygen-rich gas mixture's effectiveness as a combustion promoter. Furthermore, a combustion promoter comprising 50 percent oxygen by volume will, in some instances, be inadequate for satisfactory operation at idle. For these reasons, a useful, oxygen-based combustion promoter for ammonia should contain at least about 80 percent oxygen by volume.

Although operation at the MBT knock limit is possible after the engine is fully warmed up, it is preferred to run at the rough limit because the efficiency of the engine generally decreases with increasing oxygen fraction in excess of that required at the rough limit, and the MBT knock limit uses a higher oxygen fraction than the rough limit does at a given load. A significant efficiency loss occurs if the oxygen fraction X is greater than about 0.30-0.35.

For some instances of operation at the rough limit at 1600 RPM near idle, the oxygen fraction X is about 0.40 at 12:1 compression ratio, and about 0.60 at 8:1 compression ratio. Idle is a load condition for which the crankshaft torque is zero. The oxygen fraction at the rough limit near idle is thus high enough to cause an efficiency penalty. However, the oxygen fraction cannot be reduced below that which is used at the rough limit without causing excessive roughness and loss of efficiency. The use of moderate compression ratios of about 12:1-14:1 appears to minimize the rough-limit requirement for auxiliary oxygen, thus minimizing the oxygen fraction and minimizing the efficiency penalty near idle. However, in all cases the oxygen fraction at the rough limit will be less than 0.30 when the load is increased substantially above idle, and thus the efficiency penalty due to a high oxygen fraction will be absent for a substantial portion of the engine's useful operating range.

Operation at a constant COV(IMEP_{g}) generally permits slightly turning down the auxiliary oxygen input per cycle as the load increases from idle at a fixed RPM, but it is found that the engine-out ammonia emissions worsen significantly even at high load if the combustion promoter is turned off or turned down significantly from the amount required near idle.

The recommended operating algorithm for the rough limit is to run the engine at a constant auxiliary oxygen input per cycle at a given RPM. This auxiliary oxygen input is calibrated according to the rough limit near idle for each RPM. A slightly greater auxiliary oxygen input per cycle is required at the rough limit as the engine RPM increases. It is permitted to calibrate the auxiliary oxygen input per cycle according to the rough limit near idle for the highest RPM within the engine's range of operation, and then use that same auxiliary oxygen input per cycle for all engine RPM.

It is permitted to exclude fueled operation in some load regions. An engine might be throttled to loads less than idle during engine braking, for example, when a vehicle drive train continues to spin the engine even as the engine produces a negative torque. For the case of operation in the negative torque region (loads below idle), it is permitted, but not required, to turn the ammonia and auxiliary oxygen off. For operation at the rough limit, fuel and auxiliary oxygen shutoff below idle may result in the total exclusion of fueled operation in the first engine load region where only ammonia and auxiliary oxygen would otherwise be used, and a lower portion of the second engine load region may also be excluded.

In certain implementations, it may be desired to turn off the ammonia and the auxiliary oxygen in load regions for which the oxygen fraction X would otherwise exceed a particular chosen maximum, thereby excluding fueled operation within the first engine load range and possibly also excluding fueled operation within a lower portion of the second engine load range. For operation at the rough limit, the maximum oxygen fraction may be chosen to permit fueled operation at low RPM idle, such that the engine may be maintained in a low RPM idling rest condition. At high RPM, the threshold load, below which the ammonia and the auxiliary oxygen are turned off, may occur slightly above idle. In some instances, the engine may be turned off altogether if the load falls below a particular chosen value or condition.

In certain implementations, an exhaust catalytic converter is included and at least one exhaust gas oxygen sensor is electrically coupled to the electronic control module. The amount of ammonia combusted in the combustion chamber may be at least partially determined by one or more exhaust gas oxygen sensors, e.g. trimming the ammonia flow using one or more oxygen sensor signals, such that the ammonia flow is made to respond to one or more of the following: the net balance between the oxidizer and reducer in the exhaust gas as sensed by an engine-out exhaust gas oxygen sensor, the state of the catalytic converter as sensed by a post-catalyst exhaust gas oxygen sensor.

It is believed that portions of the operating map in which the engine burns a stoichiometric mixture of ammonia and pure oxygen, might produce exceedingly high exhaust gas temperatures. However, for operation near the rough limit, the first engine load range in which a stoichiometric ammonia/oxygen mixture is used, the load is substantially below idle, where the ammonia and oxygen mass flows are small, heat transfer removes a large fraction of the heat from the combustion gases, and the exhaust gas temperatures were found not to diverge. In fact, the high oxygen fraction near idle nearly perfectly offsets the effects of low mass flow, and the exhaust gas temperature was found to be very nearly constant with respect to load, for loads above idle. However, if the engine is run substantially above idle on a stoichiometric mixture of ammonia and pure oxygen, such as for the MBT knock limit, the exhaust gas temperatures were found to diverge, sometime reaching temperatures about 200° C. higher than for a comparable operating point using a stoichiometric mixture of gasoline and air. Operation at the rough limit appears to be necessary to keep exhaust gas temperatures from diverging during warmed-up, steady-state operation.

The engine can have any of various compression ratios. In one instance, the compression ratio of the engine is greater than about 8:1, such as between about 8:1 and about 12:1. In other instances, the compression ratio is greater than about 12:1, such as between about 12:1 and about 14:1. In some instances a compression ratio between about 12:1 and 14:1 was found to minimize the auxiliary oxygen requirement at the rough limit.

Although the preferred embodiment uses an electronic control module to control the spark advance, ammonia input, and auxiliary oxygen input, it is anticipated that the ammonia input, oxygen input and spark timing may be controlled by purely mechanical means when precise control of the ammonia/total oxygen equivalence ratio is not required. A portion of the ammonia flow module may be incorporated into the air flow module, for example, as an air/ammonia carburetor with throttle plate. However, closed loop equivalence ratio control, using one or more oxygen sensors, requires an electronic unit which reads one or more oxygen sensor signals and adjusts the ammonia flow module accordingly. An electronic control module may consist of one or more components which may be distributed.

This invention is anticipated to be operable with other embodiments. For example, a 4-cycle piston engine is known to work with ammonia promoted with an auxiliary oxygen input. However, the invention would also work in much the same way with a different engine type, such as a rotary engine or any other kind of engine which features a combustion chamber that undergoes combustion chamber opening for intake, combustion chamber closure, compression, combustion, expansion, and combustion chamber opening for exhaust.

Various intake configurations may be used, for example the ammonia and auxiliary oxygen may be introduced either upstream or downstream of the air metering module. When a turbocharger or positive displacement supercharger is active, a small, carefully controlled portion of the ammonia may be injected as a liquid into the intake line and then fully vaporized in the intake line to provide a controlled degree of cooling, thereby removing the need for an intercooler. Direct in-cylinder (or other combustion chamber) injection of a portion of the ammonia and/or auxiliary oxygen may be used, provided that a substantially homogeneous, gaseous, and stoichiometric mixture is assured at the time of ignition. In some implementations, the ammonia is drawn from the tank in liquid form, fully vaporized by heat exchange with the exhaust line and/or coolant loop, and then delivered into the intake line in gaseous form. The various ammonia, oxygen, and air metering modules may be distributed over several components, for example an air metering module may consist of a throttle plate and a turbocharger, or the air metering module may consist of a turbocharger and an intake valve timing strategy, for example early intake valve closing, which is used for varying the intake mass per cycle.

Spark ignition with a single spark plug is known to work with ammonia promoted with an auxiliary oxygen input, but other igniters which provide positive ignition would also work in much the same way, such as laser igniters, plasma jet igniters, and other configurations of igniters such as dual ignition. The use of enhanced ignition is anticipated to reduce the quantity of auxiliary oxygen required at the rough limit, and thus reduce the engineering requirements of the auxiliary oxygen source. The use of enhanced ignition may also reduce the spark advance requirement, thereby reducing the spark advance variability and also the possible spark advance error. Nevertheless, the basic features of the ammonia/oxygen operating space are anticipated to remain the same when a different ignition system is used.

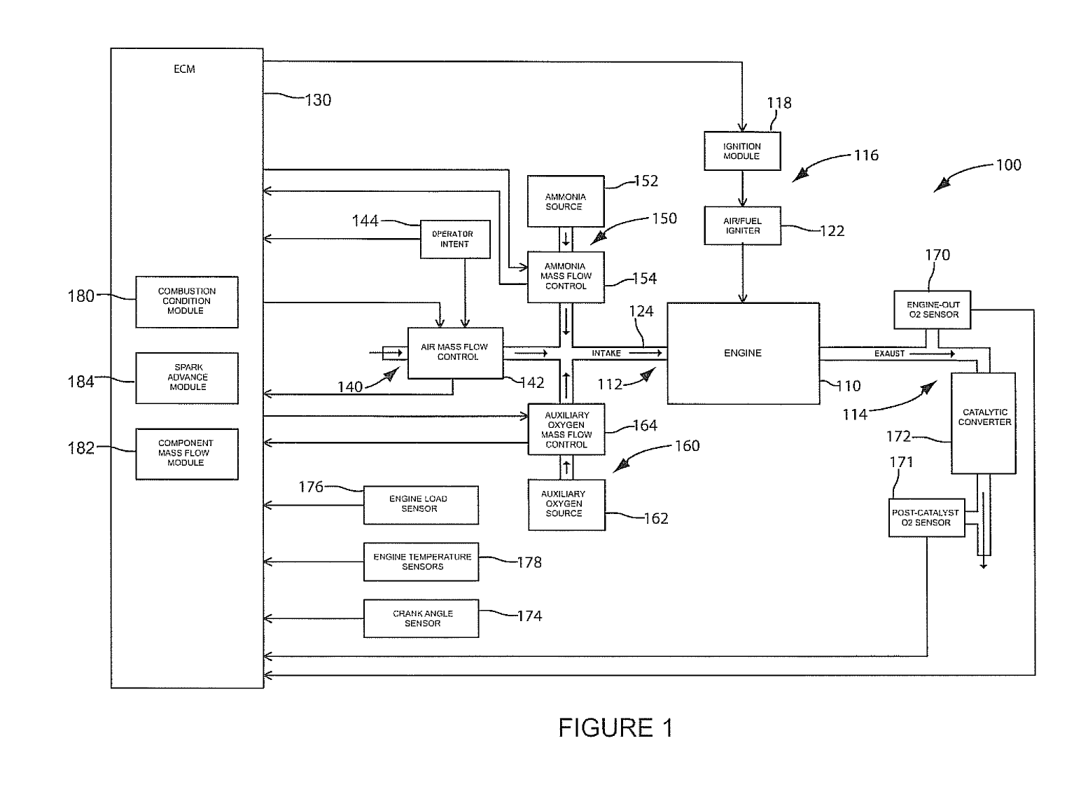

Referring to FIG. 1, and according to one representative embodiment, internal combustion engine system 100 includes a spark ignition engine 110 coupled to an intake system 112 and an exhaust system 114. The intake system 112 is coupled to respective inlets of one or more combustion chambers or cylinders (not shown) of the engine 110 and the exhaust system 114 is coupled to respective outlets of the one or more combustion chambers of the engine. The engine 110 further includes an ignition system 116. The ignition system 116 includes igniters 122 each positioned in spark igniting communication within a respective combustion chamber. The igniters 122 are coupled to an ignition module 118 to provide the energy for producing the spark of the igniters 122. The ignition module 118 is in electrical communication with an electronic control unit or module 130, such as an engine control module. In some implementations, each igniter 122 is a conventional spark plug. In other implementations, the igniters 122 can be any of various conventional spark inducing devices, such as a plasma spark igniter and laser spark igniter.

The intake system 112 includes an air intake system 140, an ammonia intake system 150, and an auxiliary oxygen intake system 160 each coupled to a combustion chamber intake line 124. The intake line 124 feeds combustible materials into the combustion chamber.

The air intake system 140 includes an air mass flow rate metering device 142, such as a throttle body valve, operable to control the mass flow rate of air from an air source (not shown), such as the surrounding environment of the engine, into the air combustion chamber intake line 124. The air mass flow rate metering device 142 can be directly or indirectly controlled at least partially according to the intent 144 of the operator and/or according to the electronic control module 130. For example, in an automobile engine application, if the operator desires to increase speed, the operator can press down on the accelerator of the automobile, which will signal or cause the air mass flow rate metering device 142 to increase the mass flow rate of air into the intake line 124, or a signal from the accelerator pedal may be received by the ECM 130, which causes the air mass flow rate metering device 142 to change the mass flow rate of air into the intake line 124. The operator's intent 144 is also communicated with the electronic control unit 130, such as by an electronic signal from the accelerator pedal or throttle position sensor. Although not shown, the air intake system 142 may be coupled to a forced air induction system, such as a supercharger or turbocharger, to increase the pressure of the air entering the intake line 124. The air intake system 142 may also include the use of a special intake valve timing strategy (not shown) to change the mass air flow, possibly in combination with a turbocharger or supercharger. The air intake system 142 may also be operable to send information through signals to the ECM 130, such as a mass air flow signal, an air temperature signal, an air humidity signal, a signal containing information about the state of the turbocharger, or other signals.

The ammonia intake system 150 includes an ammonia source 152 coupled to an ammonia mass flow rate metering device 154. The ammonia mass flow rate metering device 154 is operable to control the mass flow rate of ammonia from the ammonia source 152 into the intake line 124. The ammonia mass flow rate metering device 154 is electrically coupled to the electronic control unit 130 and controls the mass flow rate of ammonia into the intake line 124 in response to communications received from the electronic control unit 130. The ammonia mass flow rate metering device 154 may be further operable to send one or more signals to the ECM 130. These signals may contain information about the ammonia temperature, ammonia pressure, ammonia mass flow calibration, or other relevant information.

The auxiliary oxygen intake system 160 includes an auxiliary oxygen source 162 coupled to an auxiliary oxygen mass flow rate metering device 164. The auxiliary oxygen mass flow rate metering device 164 is operable to control the mass flow rate of auxiliary oxygen from the auxiliary oxygen source 162 into the intake line 124. Like the ammonia mass flow rate metering device 154, the auxiliary oxygen metering device 164 is electrically coupled to the electronic control unit 130 and controls the mass flow rate of auxiliary oxygen into the intake line 124 in response to communications received from the electronic control unit 130. The ammonia mass flow rate metering device 154 and auxiliary oxygen mass flow rate metering device 164 can be any of various conventional variable rate metering or dispensing pumps and valves. The auxiliary oxygen can be an oxygen-rich gas mixture containing at least about 80% oxygen by volume. The auxiliary oxygen metering device 164 may be operable to send one or more signals containing information about auxiliary oxygen mass flow, auxiliary oxygen purity, temperature and pressure to the ECM.

The ammonia source 152 is separate from the auxiliary oxygen source 162. The ammonia and the auxiliary oxygen are separately stored before being independently metered into the intake line 124 to form an ammonia and auxiliary oxygen mixture. In some implementations, the auxiliary oxygen source 162 is operable to obtain the auxiliary oxygen by extraction from the surrounding air. In other implementations, the auxiliary oxygen source 162 is a tank of high pressure oxygen gas.

The exhaust system 114 includes an engine-out oxygen sensor 170 and post-catalyst oxygen sensor 171 in electronic communication with the electronic control unit 130. The oxygen sensor 170 senses the oxygen content of the exhaust gas exiting the engine 110 and transmits the sensed oxygen level to the electronic control unit 130. The oxygen sensor 171 senses the oxygen content of the exhaust gas exiting the catalytic converter 172 and transmits the sensed oxygen level to the electronic control unit 130. In certain implementations, the oxygen sensor 170 senses the amount of oxidizer and reducer in the exhaust gas, and the effective oxygen content is determined by measuring the net balance of oxidizer and reducer in the exhaust gas. In some implementations, the oxygen sensor 171 senses the state of the catalytic converter 172. The oxygen sensors 170 and 171 can be any of various conventional oxygen sensors known in the art.

The engine system 100 further includes several sensors configured to sense various operating conditions of the engine. For example, the engine system 100 includes a crank angle sensor 174 and an engine load sensor 176 each coupled to the engine 110. In certain implementations, the engine load sensor 176 can include, but is not limited to, a throttle position sensors, mass air flow sensors, manifold pressure sensors, manifold temperature sensors, ambient air pressure sensors, cylinder pressure sensors and/or direct torque sensors. The engine crank angle sensor 174 senses the crank angle of the engine 110. The ECM 130 can infer RPM from the readings of crank angle sensor 174. The engine load sensor 176 senses the engine load of the engine 110. The engine load can be represented by the specific fuel input, which is the total fuel lower heating value energy input per cycle, divided by the swept cylinder volume of the combustion chamber. The engine load can also be represented by the gross indicated mean effective pressure or the brake mean effective pressure for each cycle. The engine temperature sensors 178 may include sensors for engine oil temperature, engine intake temperature, engine coolant temperature, or other temperatures. Temperature information is needed to determine the state of warm-up of the engine, and also to calculate spark advance, ammonia input and auxiliary oxygen input. Periodically, such as after each combustion cycle, each of the sensors 174, 176, 178 transmits the sensed data to the electronic control unit 130.

The electronic control unit 130 includes a combustion condition module 180. The combustion condition module 180 determines a desired or target combustion condition of the engine 110. The desired combustion condition can be any condition at or between a rough limit and a knock limit as will be described in more detail below. Generally, the rough limit and knock limit are based at least partially on the oxygen fraction in the mixture combusted by the engine 110. In some implementations, the combustion condition module 180 determines the desired target combustion condition based on state of cranking during startup and/or state of warm-up. In some implementations, the combustion condition module 180 automatically determines the desired target combustion condition based on any of a number of factors, such as, for example, engine coolant temperature, engine oil temperature, engine intake temperature, elapsed time since starting, the engine-out ammonia emissions, the engine-out emissions of oxides of nitrogen, exhaust gas temperature, an exhaust system component temperature, moisture content of the air, auxiliary oxygen impurity content, and overall engine efficiency.

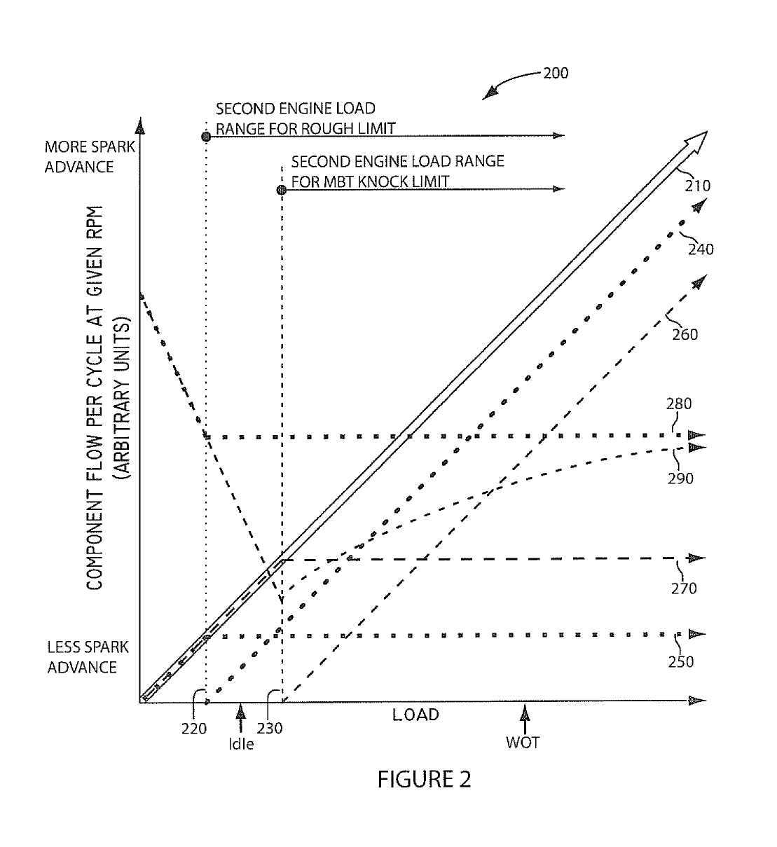

The electronic control unit 130 also includes a component mass flow module 182. The component mass flow module 182 is configured to determine the ammonia to auxiliary oxygen ratio, or the amount of ammonia compared to the amount of auxiliary oxygen to be combusted in the engine 110, based at least partially on the desired combustion condition, RPM of the engine, the engine load, and any of various other operating parameters. The component mass flow module 182 can include a memory in which a look-up table based on one or more operating maps, such as shown in FIGS. 2, 4 and 5, is stored. The ammonia to auxiliary oxygen ratio can be determined from the look-up table based on the current and/or desired operating parameters of the engine 110.

The electronic control unit 130 also includes a spark advance module 184 configured to determine the spark advance or timing of the spark generated by the igniters 118 relative to the sensed angle of the crank. Similar to the component mass flow module 182, the spark advance module 184 can determine the desired spark advance from a look-up table based on one or more operating maps, such as shown in FIGS. 2, 4 and 5, stored in a memory of the module.

As will be described in more detail below, operation of a spark ignition internal combustion engine according to one or more of the operating maps shown in FIGS. 2, 4 and 5 promotes decreased emissions, increased efficiency, and lower consumption of fossil fuels without significant degradation in performance of the engine compared to conventional gasoline powered internal combustion engines.

Referring to FIG. 2, according to one embodiment, an operating map 200 for achieving stoichiometric operation of the engine 110 across all operating loads of the engine is shown. As used herein, stoichiometric operation is defined as operation within a specific percentage of actual stoichiometric operation. For example, in some instances, the specific percentage is +−1% of actual stoichiometric operation. In other instances, the specific percentage is +−0.2 percent of actual stoichiometric operation. In yet other instances, the specific percentage is +−5 percent of actual stoichiometric operation. Generally, the engine system 100 is controllable to operate the engine 110 in a first engine load range and a second engine load range. In the first engine load range, the engine operates, runs or is fueled solely on a stoichiometric mixture of ammonia and auxiliary oxygen. In the second engine load range, the engine operates, runs or is fueled on a mixture of ammonia, air and auxiliary oxygen. All maps in FIGS. 2, 4 and 5 assume an auxiliary oxygen composition of 100% pure oxygen. In some implementations, the engine may be run solely in the second engine load range.

As shown on the operating map 200, the engine 110 operates in the first engine load range when the engine load is between zero and the air cut-in point load, i.e., the load at which the air cut-in point occurs. The air cut-in point occurs at the lowest engine load in which air can be added to the mixture to achieve the desired combustion condition. In the first engine load range, the air mass flow control unit 142 sets the mass flow rate of the air to zero or very near zero and increases the mass flow rate of the auxiliary oxygen by varying the auxiliary oxygen mass flow rate metering device 164 as the load increases from zero to the air cut-in load. Similarly, the ammonia mass flow rate metering device 154 increases the mass flow rate 210 of ammonia into the intake line 124 as the load increases from zero to the air cut-in load. In the first engine load range, the auxiliary oxygen and ammonia increase in a substantially constant ratio as load increases.

It is noted that the operating map 200 is used to show the mass flow rate trends of the various components relative to each other at a given engine RPM and therefore, the component flow per cycle units far each component is arbitrary and not necessarily absolute. For example, a portion of the mass flow rate for the auxiliary oxygen and ammonia are shown overlapping each other for illustrating the relative mass flow rate trends of auxiliary oxygen and ammonia and not the actual mass flow rate amounts. In other words, the mass flow rate of ammonia is drawn in such a way that, for a given load, the vertical height of the ammonia line is equal to the sum of the vertical heights of the air and auxiliary oxygen lines as a way to graphically show stoichiometry. The total oxidizing capacity of the air plus auxiliary oxygen must be balanced with the reducing capacity of the ammonia.

Once the load has increased to the air cut-in point, the engine system 100 switches to the second engine load range by controlling the auxiliary oxygen mass flow rate metering device 164 to hold the auxiliary oxygen mass flow rate constant and controlling the ammonia mass flow rate metering device 154 to introduce ammonia into the intake line 124. In the second engine load range, the mass flow rate of the auxiliary oxygen remains steady and the ammonia mass flow rate metering device 154 increases the mass flow rate of ammonia as the engine load increases. Accordingly, in the second engine load range, the ratio of ammonia to auxiliary oxygen in the fuel mixture combusted by the engine increases and the oxygen fraction decreases as the engine load increases. Moreover, the electronic control unit 130, with feedback from the oxygen sensors 170 and 171, controls the ammonia flow rate in the fuel mixture such that stoichiometric combustion of the ammonia, air and auxiliary oxygen is maintained for each engine cycle at any load at or above the air cut-in point.

In one implementation, the combustion condition module 180 may determine that the desired combustion condition is the rough limit. Accordingly, in the second engine load range, electronic control unit 130 controls the auxiliary oxygen input of the mixture such that the engine roughness, i.e., the COV(IMEP_{g}), is below a predetermined percentage. Generally, the rough limit corresponds to operation of the engine at a nominal efficiency, e.g., roughness of less than about 3 percent, on the lowest amount of auxiliary oxygen or the lowest oxygen fraction. In some implementations, the roughness is less than about 3 percent, and in yet other implementations, the roughness is between about 3 percent and about 5 percent. In other words, operation at the rough limit seeks to minimize the quantity of auxiliary oxygen used. Because less auxiliary oxygen is used, operation at the rough limit results in lower power consumption by an oxygen extractor than operation at the knock limit. Therefore, in some instances, the desired target combustion condition may be the rough limit when the engine is fully warmed up.

In another implementation, the combustion condition module 180 may determine that the desired combustion condition is the MBT knock limit. Accordingly, in the second engine load range, electronic control unit 130 controls the ammonia to auxiliary oxygen ratio of the mixture such that engine operates substantially knock-free. Generally, the MBT knock limit corresponds to operation of the engine on the highest amount of auxiliary oxygen or the highest oxygen fraction without knock while maintaining the maximum brake torque (MBT) spark advance as will be described in more detail below. In some instances, the desired target combustion condition may correspond to an auxiliary oxygen input per cycle which is at or slightly above the MBT knock limit when one or more of the following factors is true: the engine is not fully warmed up, and the engine is being cranked during startup.

As shown in FIG. 2, if the desired combustion condition is the rough limit, the air cut-in point is a rough limit air cut-in point. In some implementations, the engine load range between zero load and the rough limit air cut-in point corresponds to the engine loads substantially below idle. If the desired combustion condition is the MBT knock limit, the air cut-in point is an MBT knock limit air cut-in point. The rough limit air cut-in point occurs at a rough limit air cut-in point load 220 and the MBT knock limit air cut-in point occurs at a knock limit air cut-in load 230. As shown, the rough limit air cut-in load 220 is a lower engine load than the MBT knock limit air cut-in load 230. In other words, air is added to the auxiliary oxygen sooner, e.g., at lower loads, when operating at the rough limit than when operating at the MBT knock limit.

When operating at the rough limit, air is introduced into the intake line 124 at the rough limit air cut-in load 220. As the load increases from the rough limit air cut-in load 220 to the maximum load of the engine, the rough limit flow rates 240 of air and 210 of ammonia are steadily increased, and the rough limit flow rate 250 of the auxiliary oxygen is held substantially constant. Accordingly, the ratio of ammonia to auxiliary oxygen steadily increases and the oxygen fraction decreases with increasing load across the entire operating load of the engine above the rough limit air cut-in load 220. As used herein, holding the mass flow rate of the auxiliary oxygen substantially constant can include nominal increases or decreases in the mass flow rate of the auxiliary oxygen, such as within a small percentage, e.g., .+−3%, of the total charge content of the auxiliary oxygen. In some cases, for simplicity, the mass flow rate of the auxiliary oxygen may be held to a constant value which is sufficient for all loads within the second engine load range, for a given RPM.

When operating at the MBT knock limit, air is introduced into the intake line 124 at the MBT knock limit air cut-in load 230. As the load increases from the MBT knock limit air cut-in load 230 to the maximum load of the engine, the MBT knock limit flow rates 260 of air and 210 of ammonia are steadily increased, and the knock limit flow rate 270 of the auxiliary oxygen is held constant. Accordingly, the ratio of ammonia to auxiliary oxygen steadily increases and the oxygen fraction decreases with increasing load across the entire operating load of the engine above the MBT knock limit air cut-in load 230.

The concept of spark advance and its relationship with engine knock is well known in the art. In conventional single fuel spark ignition engines, as the engine load increases, the spark advance is retarded or delayed to avoid engine knock and/or to maintain the MBT condition. Referring again to FIG. 2, in the engine system 100, the spark advance is retarded in the first engine load range, e.g., before the air cut-in, but the spark advance is held substantially constant in the rough limit second engine load range, e.g., after the rough limit air cut-in. As used herein, holding the spark advance substantially constant can include small variations in the spark advance. For the MBT knock limit, the spark advance increases with increasing load in the second engine load range, and the spark advance for the MBT knock limit appears to converge with the spark advance at the rough limit as the load is increased within the second engine load range.

More specifically, when operating at the rough limit, the rough limit spark advance 280 is steadily decreased or delayed as load increases from zero to the rough limit air cut-in load 220. The rough limit spark advance 280 is held substantially constant up to the maximum engine load of the engine 110.

When operating at the MBT knock limit, the MBT knock limit spark advance 290 is steadily decreased or delayed as load increases from zero to the knock limit air cut-in load 230. The spark advance 290 is then increased, and it converges with the rough limit spark advance 280 as the load is increased within the second engine load range.

The spark advance is held substantially constant in the rough limit second engine load range because of the neutral effect of adding ammonia and air in stoichiometric proportions. In other words, as the mixture density of the cylinder increases in the second engine load range, the ratio of ammonia to auxiliary oxygen increases and the oxygen fraction decreases. The decrease in the oxygen fraction offsets the effects of increased mixture density and maintains the flammability of the mixture at a relatively constant level. Further, ammonia has a very high octane rating. Therefore, the spark advance can be held substantially constant in the second engine load range.

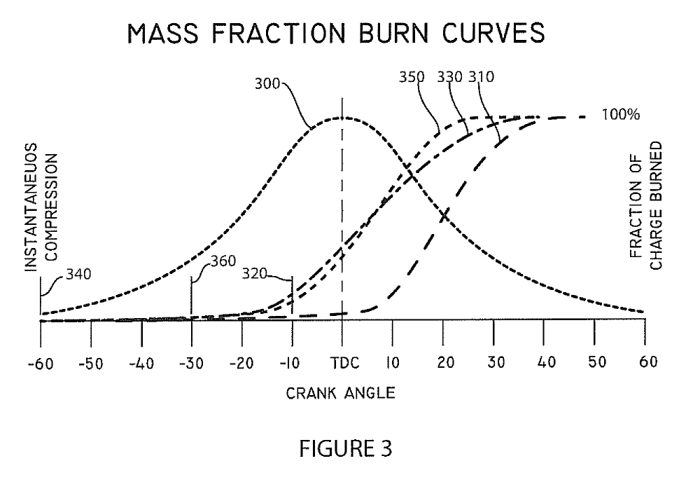

The ability to hold the spark advance substantially constant at MBT spark advance in the second engine load range over a range of high engine loads promotes improved thermal efficiency of the engine. Referring to FIG. 3, mass fraction burn curves at MET spark advance for various operating conditions versus the crank angle of the engine and the instantaneous compression curve 300 are shown. FIG. 3 also shows the mass fraction burn curve 310 for spark timing retarded of MBT, or for operation with auxiliary oxygen input in excess of the MBT knock limit such as may be used during cranking at startup. The mass fraction burn curve 310, which represents overall combustion timing which is retarded of MET, typically begins at the spark ignition point 320, at a spark advance less than about 20° before top center. The mass fraction burn curve 330 for the engine 110 operating at the rough limit in the second engine load range at high loads typically begins at the spark ignition point 340. Curve 330 also corresponds to MET spark advance at the rough limit for the first engine load range in which a stoichiometric mixture of auxiliary oxygen and ammonia is used. The mass fraction burn curve 350 for the engine 110 operating at the MBT knock limit in the second engine load range at high loads typically beings at the spark ignition point 360. Curve 350 also corresponds to MET spark advance at the MET knock limit for the first engine load range near the knock limit air cut-in load 230. The spark ignition points 320, 340, 360 are timed to begin when the crank angle reaches about −20 to 0°, −80 to −40°, and −40 to −20°, respectively.

Generally, the thermal efficiency of an engine is dependent on the amount of combustion that occurs at or near top dead center (TDC). As the bulk of combustion occurs further away from TDC after TDC is reached, the thermal efficiency of the engine is likely to decrease. In contrast, as the bulk of combustion occurs closer to TDC after TDC is reached, the thermal efficiency of the engine is likely to increase.

Because additional ammonia and air in stoichiometric proportions has a neutral effect on the flammability of the ammonia/air/auxiliary oxygen mixture at high loads, ammonia and air are being added, and the auxiliary oxygen input per cycle is being held constant, the flammability of the mixture is not increasing at the rate experienced with a stoichiometric mixture of ammonia and auxiliary oxygen alone. Accordingly, the bulk of combustion with the engine 110 operating at either the rough limit or the MBT knock limit in the second engine load range at high loads occurs close to TDC, which results in a higher thermal efficiency, and thus lower exhaust gas temperatures, than conventional gasoline powered engines at the same loads. Additionally, the higher engine efficiency achieved by running the engine 110 on ammonia with auxiliary oxygen as discussed above may make an engine running on ammonia more economically favored over an engine running on gasoline even when the cost of ammonia is the same as that of gasoline on a lower heating value energy basis.

The engine 110 fueled by ammonia and a auxiliary oxygen in the second engine load range according to the operational map of FIG. 2 is capable of operating at higher loads than conventional engines, e.g., gasoline fueled engines. The oxygen-enriched ammonia-fueled engine may be run as a normally aspirated engine, for which WOT is the maximum load. However, if so equipped, the engine may run in the supercharge regime (load>WOT) without knock. The line endings in the top and right sides of operating spaces in FIGS. 2 and 4-5 are drawn with arrows to imply that these operating spaces are open ended on the top and right sides. That is, the trends shown point toward uncharted territory within which acceptable operation can likely be achieved provided that the engine is designed to withstand the high firing pressures likely to be encountered in those regions. In some instances the maximum engine load attainable for ammonia may be much higher than that the maximum attainable load for conventional gasoline fueled engines. The ability to run the engine 110 on ammonia at higher engine loads compared to conventional engines results in more power and higher operating efficiency. Additionally, engines run on ammonia and auxiliary oxygen according to the operating map of FIG. 2 can be smaller and more lightweight than conventional engines, while producing the same power output as conventional engines.

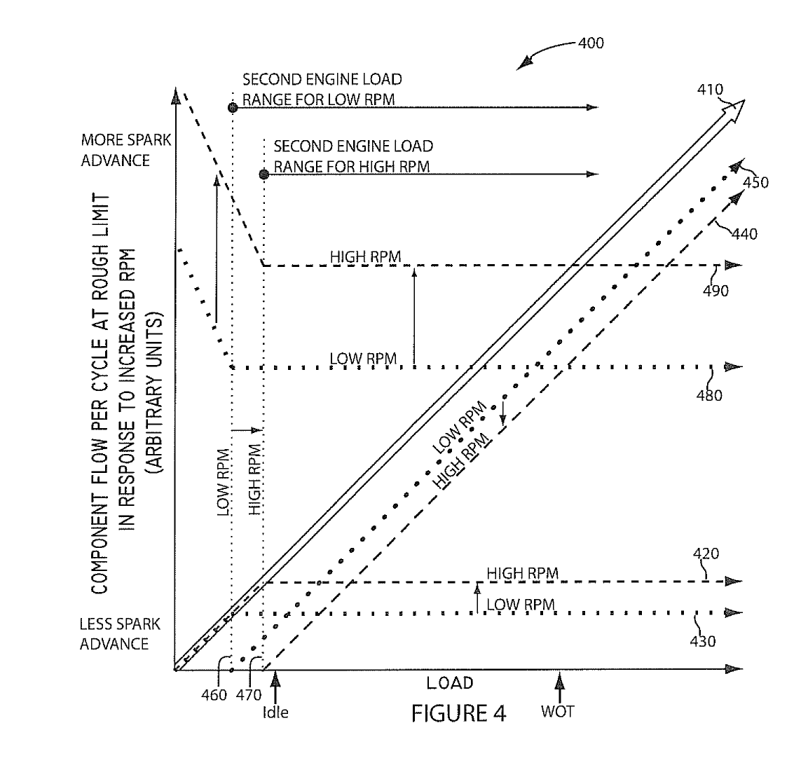

In some implementations, the RPM at which the engine 110 is operated affects the operating map of the system 100. FIG. 2 depicted an operating map 200 of the engine system 100 at a given engine RPM. FIG. 4 depicts operating map 400 of the engine system 100 similar to map 200, but showing the effects on the map of varying the RPM of the engine for operation at the rough limit.

As shown in FIG. 4, when operating at the rough limit, a change in the RPM of the engine 110 corresponds to a shift in the air cut-in load and the spark advance. The ammonia input per cycle for both high and low RPM is indicated at 410, the auxiliary oxygen input per cycle at high RPM is indicated at 420, the auxiliary oxygen input per cycle at low RPM is indicated at 430, the air input per cycle at high RPM is indicated at 440, and the air input per cycle at low RPM is indicated at 450. The low RPM air cut-in load 460, i.e., the air cut-in load when operating the engine 110 at a low RPM, is lower than the high RPM air cut-in load 470, i.e., the air cut-in load when operating the engine at a high RPM. Accordingly, the rough limit air cut-in point occurs at lower loads at low RPM and higher loads at high RPM. In other words, the oxygen fraction of the mixture combusted in the engine at a given engine load can be higher at higher RPM, and lower at lower RPM.

The shift in air cut-in loads between low and high RPM also corresponds to a shift in the spark advance. The spark advance at low RPM is indicated at 480 and the spark advance at high RPM is indicated at 490. As shown, both the low RPM spark advance 480 and the high RPM spark advance 490 are steadily delayed as the engine load increases from zero to the low RPM air cut-in load 460 and high RPM air cut-in load 470, respectively. As the engine load increases, both the low and high RPM spark advance 480, 490 are held constant as the load increases. More specifically, the low RPM spark advance 480 is held at a more delayed spark advance than the high RPM spark advance 490.

Generally, as shown in FIG. 4, the higher the RPM, the higher the auxiliary oxygen input per cycle at the rough limit. As the RPM increases, a higher load is required before air can be added while holding the auxiliary oxygen input constant with increasing load and increasing ammonia input. Otherwise the engine would run inefficiently below the rough limit. The rough limit air cut-in point for low-to-medium RPM occurs substantially below idle. However, for high RPM the rough limit air cut-in point may occur near idle, and in some instances it may occur above idle. Because the auxiliary oxygen input per cycle at the rough limit increases with increasing RPM, a doubling of the RPM will somewhat more than double the auxiliary oxygen mass flow per unit time for operation near the rough limit.

In some cases, for simplicity, the auxiliary oxygen input per cycle may be held to a constant value which is sufficient for all loads within the second engine load range, for a given RPM. In some cases, for further simplicity, the auxiliary oxygen input per cycle may be held to a constant value which is sufficient for all loads within the second engine load range for the highest RPM within the engine's range of operation, and this auxiliary oxygen input per cycle would be sufficient for all RPM and all loads within the second engine load range.

In some instances, the engine 110 can be equipped with a turbocharger or supercharger and the engine can be made smaller and/or fewer cylinders used such that the average load is higher for a given power output. In this manner, if operation at the rough limit is used, the engine can be run at a lower average oxygen fraction to reduce the average power consumption of an oxygen separator.

In some vehicular implementations, such as when the swept cylinder volume per cylinder is about 0.6 liters, the low RPM is between about 500 RPM and about 1,000 RPM and the high RPM is between about 4,000 RPM and about 6,000 RPM. However, in other implementations, such as when the swept cylinder volume is greater than or less than 0.6 liters, the low and high RPM ranges may be nominally or substantially different.

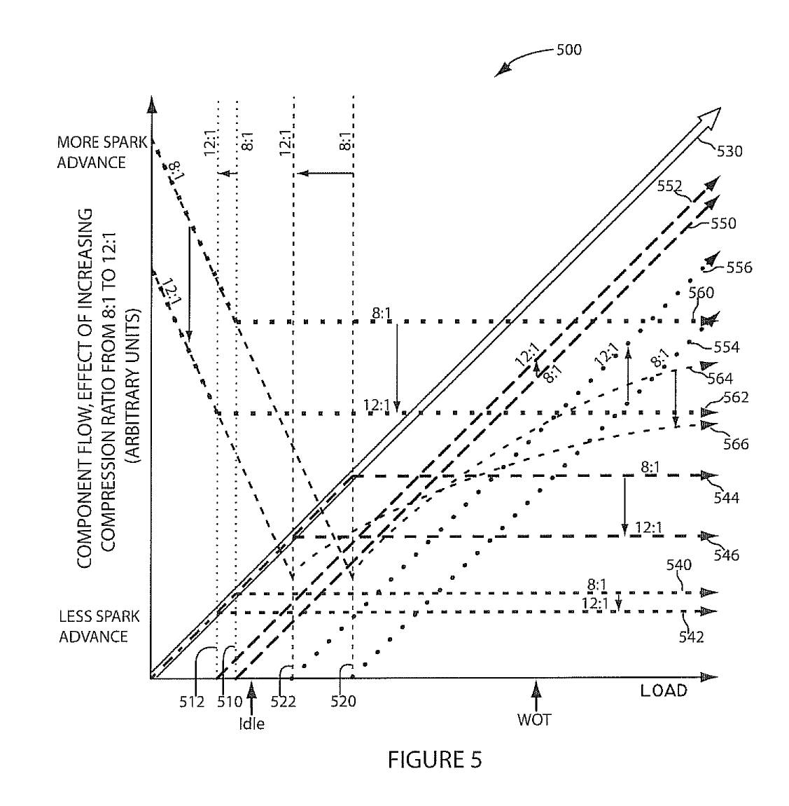

In some implementations, the compression ratio of the engine 110 affects the operating map of the system 100. FIG. 2 depicted an operating map 200 of the engine system 100 with the engine 110 at a given compression ratio. FIG. 5 depicts respective an operating map 500 of the engine system 100 similar to map 200, but showing the effects on the map of varying the compression ratio of the engine 110.

Generally, increasing the compression ratio of the engine from 8:1 to 12:1 results in a lowering of the air cut-in load and an overall thermal efficiency gain in the engine. For example, the 8:1 compression ratio rough limit air cut-in load 510 is higher than the 12:1 compression ratio rough limit air cut-in load 512. Similarly, the 8:1 compression ratio MBT knock limit air cut-in load 520 is higher than the 12:1 compression ratio MBT knock limit air cut-in load 522. Accordingly, in some implementations, the use of air occurs earlier on in the operation load range of the engine with engines having a higher compression ratio. Therefore, at a given operating load in the second engine load range, the oxygen fraction is lower for a 12:1 compression ratio engine compared to an 8:1 compression ratio engine. Further, the difference between the rough limit air cut-in loads 510, 512 for 8:1 and 12:1 compression ratios, respectively, is less than the difference between the MBT knock limit air cut-in loads 520, 522 for 8:1 and 12:1 compression ratios, respectively. In other words, the oxygen fraction is less dependent on compression ratio at the rough limit, than at the MBT knock limit. Therefore, a change in compression ratio generally has a greater impact on the oxygen fraction when the engine is operating at the MBT knock limit than when the engine is operating at the rough limit.

Generally, the various mass flow rate trends for air, auxiliary oxygen and ammonia in FIG. 5 are the same as the mass flow rate trends for air, auxiliary oxygen and ammonia in FIG. 2. As will be recognized, the main difference between the various mass flow rates of FIG. 5 and FIG. 2 is the point at which air is introduced and the point at which the auxiliary oxygen is held constant. For convenience, the ammonia mass flow rate for both 8:1 and 12:1 compression ratios is indicated at 530, the rough limit auxiliary oxygen mass flow rate at 8:1 compression ratio is indicated at 540, the rough limit auxiliary oxygen mass flow rate at 12:1 compression ratio is indicated at 542, the MET knock limit auxiliary oxygen mass flow rate at 8:1 compression ratio is indicated at 544, the MBT knock limit auxiliary oxygen mass flow rate at 12:1 compression ratio is indicated at 546, the rough limit air mass flow rate at 8:1 compression ratio is indicated at 550, the rough limit air mass flow rate at 12:1 compression ratio is indicated at 552, the MBT knock limit air mass flow rate at 8:1 compression ratio is indicated at 554, and the MBT knock limit air mass flow rate at 12:1 compression ratio is indicated at 556.

FIG. 5 also shows the effects of compression ratio on the spark advance. The respective spark advances for operation at the rough and MET knock limits for 8:1 and 12:1 follow the same general trends as the associated spark advances shown in FIG. 2 and discussed above. However, the spark advances are shifted as the compression ratio moves between 8:1 and 12:1. For example, the 8:1 compression ratio rough limit spark advance 560 is greater than the 12:1 compression ratio rough limit spark advance 562 across the entire operating load range of the engine 110. The MBT knock limit spark advances 564 and 566 converge with the respective rough limit spark advances 560 and 562 at high load.

In operation, the engine 110 is started and the operator's intent 144 is determined and transmitted to the electronic control unit 130 and the air flow metering device 142. Based on the operator's intent 144, the air mass flow metering device 142 increases or decreases the amount of air flowing into the intake line 124. The electronic control unit 130 processes the operator's intent 144, along with data received from one of several sensors sensing conditions of the system 100, such as the oxygen sensor 170, crank angle sensor 174, and engine load sensor 176. Based on the operator's intent 144, data from the various sensors, and/or operator's input, the combustion condition module 180 determines the desired combustion condition of the engine 110.

Using the desired combustion condition determined by the combustion condition module 180, the operator's intent 144, and data from the several sensors, the component mass flow module 182 and the spark advance module 184 consult the operating maps of FIGS. 2, 4 and 5 to determine the appropriate oxygen fraction for substantially stoichiometric operation at the desired combustion condition. The electronic control unit 130 then controls the ammonia mass flow rate device 154 and/or the auxiliary oxygen mass flow rate device 164 to introduce a fuel mixture having the appropriate ammonia to auxiliary oxygen ratio into the intake line 124. The fuel mixture and air from the air mass flow metering device 142 is then introduced into the combustion chamber of the engine for combusting in an engine cycle. The operator's intent 144 is again determined and the process is repeated using data sensed from the previous cycle's output. In this manner, operation of the engine system 100 is performed according to a closed or dynamic loop control, and, in some instances, without operator intervention.

The combustion of ammonia with a auxiliary oxygen according to the operating map described herein promotes clean emissions. Proper combustion of ammonia results in a byproduct consisting substantially of water vapor and nitrogen. In other words, proper combustion of ammonia does not result in the harmful exhaust emissions. As defined herein, harmful exhaust emissions includes any of various environmentally harmful substances, such as, but not limited to, greenhouse gas, CO, CO₂ or carbon particulates, produced by combustion of an internal combustion engine.

Because combustion of ammonia and auxiliary oxygen results in the ability to use MBT spark timing for the entire operating range of the engine, the complete combustion of ammonia occurs near top center. Therefore, the exhaust gas temperature is reduced relative to that for gasoline and large swings in the exhaust gas temperature are avoided. Lower exhaust gas temperatures and fewer gas temperature swings can substantially lengthen the service life of and reduce maintenance for the components of the exhaust system, such as, but not limited to, the exhaust valve and seat, exhaust manifold, headers, gaskets, sensors, exhaust pipes, mufflers, flanges, hangers and brackets, tail pipes, catalytic converter, and forced air induction device. Further, with lower exhaust temperatures, the requirements for the exhaust system can be relaxed, which can results in reduced manufacturing costs and vehicle weight.

Another possible advantage of using ammonia to fuel an internal combustion engine according to at least one embodiment described herein is an increase in road load efficiency compared to a similar engine run on gasoline. Because of a reduction in the throttling losses, the ability to operate at higher engine loads, and an increase in the mechanical efficiency of the engine, the road load efficiency is correspondingly increased. Further, the compression ratio of the engine can have a significant impact on the road load efficiency and thus the operating cost of the engine. For example, when operating at high load on ammonia promoted with auxiliary oxygen according to the operating maps described above, the operating cost for the engine 110 with a compression ratio of 12:1 can be about 1.5 times lower than the operating cost for an engine with a compression ratio of 9:1 operating on gasoline at a substantially throttled load.

A representative physical embodiment of an engine system operated on ammonia and auxiliary oxygen according to at least some of the above principles was tested. The results of the test have been documented and witnessed but not published as of the writing of this preliminary patent application.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An oxygen-enriched ammonia-fueled intake system for an internal combustion engine, comprising:
an intake line adapted for coupling to at least one combustion chamber;
an air flow module which is operable to control the mass flow of air into the engine intake line;
an ammonia flow module with ammonia source which are operable to control the mass flow of gaseous ammonia into the engine intake line;
an auxiliary oxygen flow module with oxygen source which are operable to control the mass flow of auxiliary oxygen into the engine intake line; and
an electronic control module which is operable to control the ammonia flow module and the auxiliary oxygen flow module and thereby control the flow rates of ammonia and auxiliary oxygen into the engine intake line to achieve a substantially stoichiometric mixture of ammonia, air and auxiliary oxygen in the combustion chamber.

2. The intake system of claim 1, wherein, in a second engine load range between an engine load associated with a target combustion condition and the maximum engine load, the electronic control module is further operative to decrease the oxygen fraction of the combined air and auxiliary oxygen portions of the mixture admitted into the combustion chamber as engine load increases.

3. An oxygen-enriched ammonia-fueled spark ignition internal combustion engine, comprising:
an engine intake line coupled to at least one combustion chamber;
an air flow module which is operable to control the mass flow of air into the engine intake line;
an ammonia flow module with ammonia source which are operable to control the mass flow of gaseous ammonia into the engine intake line;
an auxiliary oxygen flow module with oxygen source which are operable to control the mass flow of auxiliary oxygen into the engine intake line; and
an electronic control module which is operable to control the ammonia flow module and the auxiliary oxygen flow module and thereby control the flow rates of ammonia and auxiliary oxygen into the engine intake line to achieve a substantially stoichiometric mixture of ammonia, air and auxiliary oxygen in the combustion chamber(s) for each cycle of the internal combustion engine;
wherein when in a second engine load range between an engine load associated with a target combustion condition and the maximum engine load, the oxygen fraction, of the combined air and auxiliary oxygen portions of the mixture admitted into the combustion chamber(s), decreases as the engine load increases.

4. The internal combustion engine of claim 3, wherein the electronic control module is operable to control the flow rate of ammonia and auxiliary oxygen into the engine intake to operate the engine at a desired operational state between a rough limit and an MBT knock limit, wherein the oxygen fraction, of the combined air and auxiliary oxygen portions of the mixture admitted into the combustion chamber(s) at the MBT knock limit, is higher than the oxygen fraction, of the combined air and auxiliary oxygen portions of the mixture admitted into the combustion chamber(s) at the rough limit, for a given engine load.

5. The internal combustion engine of claim 4, wherein both the choice of desired operational state of the engine, and the auxiliary oxygen input at said operational state, are at least partially determined by one or more of the following: auxiliary oxygen input per cycle, ammonia input per cycle, RPM, compression ratio, engine coolant temperature, engine oil temperature, engine intake temperature, elapsed time since starting, the engine-out ammonia emissions, the engine-out emissions of oxides of nitrogen, exhaust gas temperature, an exhaust system component temperature, moisture content of the air, auxiliary oxygen impurity content, and overall engine efficiency, and wherein operation is maintained at or substantially near the rough limit when the engine is fully warmed up.

6. The internal combustion engine of claim 5, wherein the electronic control module is further operable to utilize a special control strategy during cranking at startup, wherein when the engine is being cranked at startup, the spark occurs near top center, the auxiliary oxygen input per cycle may be greater than the auxiliary oxygen input per cycle at the MBT knock limit, and the ammonia, auxiliary oxygen and air are metered into the engine in a substantially stoichiometric mixture, and wherein the engine's state of cranking is determined by at least one of the following: the engine starter's state of activation or deactivation, and engine RPM.

7. The internal combustion engine of claim 6, wherein the electronic control module is further operable to maintain MBT spark timing after the engine has started, and wherein the spark advance is at least partially determined by one or more of the following: auxiliary oxygen input per cycle, ammonia input per cycle, RPM, compression ratio, engine coolant temperature, engine oil temperature, engine intake temperature, engine intake pressure, moisture content of the air, auxiliary oxygen impurity content, elapsed time since starting, and choice of target combustion condition.

8. The internal combustion engine of claim 5, wherein when operating substantially near the rough limit, as the RPM of the engine increases, the electronic control module is operable to increase the amount of auxiliary oxygen consumed per cycle.

9. The internal combustion engine of claim 3, wherein the electronic control module is further operable in a first engine load range between zero and the engine load associated with the target combustion condition to reduce the flow rate of air to zero and achieve substantially stoichiometric combustion of ammonia and auxiliary oxygen in the combustion chamber(s).

10. The internal combustion engine of claim 9, wherein when the load is substantially below idle, the ammonia and auxiliary oxygen are turned off, thereby excluding fueled operation in at least a lower portion of the first engine load range, and in some cases also excluding fueled operation in a lower portion of the second engine load range.

11. The internal combustion engine of claim 3, wherein when in the second engine load range, as the load increases the amount of auxiliary oxygen combusted per cycle in the combustion chamber(s) remains substantially constant, and the amounts of ammonia and air combusted per cycle in the combustion chamber(s) increase.

12. The internal combustion engine of claim 3, wherein the auxiliary oxygen is an oxygen-rich gas mixture containing at least about 80% oxygen by volume, balance mostly nitrogen and argon, and wherein the oxygen source comprises a pressure swing absorption medium, for example a zeolite, which is used for extracting the oxygen-rich gas mixture from air.

13. The internal combustion engine of claim 3, wherein the air flow module comprises one or more of the following: a throttle, an intake valve timing strategy, a positive displacement supercharger and a turbocharger.

14. The internal combustion engine of claim 3, wherein the air flow module is directly controlled at least partially by operator intent, and wherein the electronic control module receives one or more signals containing information about the status of the air flow module.

15. The internal combustion engine of claim 3, wherein all of the auxiliary oxygen and at least a portion of the ammonia are introduced into a portion of the engine intake line which is downstream of the air flow module and near the intake port(s) of the combustion chamber(s), thereby eliminating at least some of the intake line filling effects which could otherwise cause a deviation from one or more prescribed operating maps when the load is suddenly changed.

16. The internal combustion engine of claim 3, wherein the electronic control module receives one or more signals containing information about operator intent, and wherein the air flow module is exclusively controlled by the electronic control module.

17. The internal combustion engine of claim 16, wherein the auxiliary oxygen and ammonia are introduced into a portion of the engine intake line which is upstream of the air flow module, thereby shielding the ammonia and oxygen equipment from the possibly elevated pressure and pressure fluctuations occurring downstream of the air flow module, and wherein the electronic control module is operable to plan and effect load changes, operable to at least partially compensate for intake line filling effects, and operable to incorporate low pass filtering in its response to operator intent, using an appropriate time constant chosen to give a reasonable compromise between obeying operator intent and minimizing any deviations from one or more prescribed operating maps.

18. The internal combustion engine of claim 3, further comprising an exhaust catalytic converter and at least one exhaust gas oxygen sensor electrically coupled to the electronic control module, wherein the amount of ammonia combusted in the combustion chamber(s) is at least partially determined by at least one of the following: the net balance between the oxidizer and reducer in the exhaust gas as sensed by an engine-out exhaust gas oxygen sensor, and the state of the catalytic converter as sensed by a post-catalyst exhaust gas oxygen sensor.

19. An internal combustion engine system, comprising:
a spark ignition internal combustion engine operable at any of various target combustion conditions between a rough limit and an MBT knock limit in a second engine load range between the engine load associated with said target combustion condition and a maximum engine load, wherein in the second engine load range a substantially stoichiometric mixture of ammonia, air and auxiliary oxygen is combusted in the combustion chamber(s);
a set of metering modules operable to control the flow rate of ammonia and the flow rate of auxiliary oxygen into the engine such that stoichiometric combustion is maintained and the auxiliary oxygen input is appropriate for the chosen target combustion condition, determinable from an operating map of the engine, wherein the fuel metering module is operable to increase the ratio of ammonia to auxiliary oxygen of the mixture with increasing engine load and decrease the ratio of ammonia to auxiliary oxygen of the mixture with decreasing engine load;
an air metering module operable to control the mass flow rate of air into the engine; and
a spark advance module operable to control the spark advance of an ignition spark for igniting the fuel.

20. The internal combustion engine system of claim 19, wherein the ammonia and auxiliary oxygen flow modules are further operable in a first engine load range between zero and the load associated with the target combustion condition to reduce the air input to zero and achieve substantially stoichiometric combustion of ammonia and auxiliary oxygen in the combustion chamber(s), and wherein the internal combustion engine system automatically switches from the first engine load range to the second engine load range when an engine load corresponding to the target combustion condition is reached.

21. The internal combustion engine system of claim 19, wherein in the second engine load range, the auxiliary oxygen flow module is operable to hold the flow rate of auxiliary oxygen substantially constant for a given RPM of the engine.

22. The internal combustion engine system of claim 19, wherein as the RPM of the engine increases when operating substantially near the rough limit in the second engine load range, the auxiliary oxygen flow module is operable to increase the quantity of auxiliary oxygen consumed per cycle.

23. The internal combustion engine system of claim 19, wherein the internal combustion engine has a compression ratio less than the compression ratio at which a prescribed auxiliary oxygen input per cycle, substantially near the auxiliary oxygen input per cycle at the rough limit, becomes greater than the auxiliary oxygen input per cycle at the MBT knock limit, for any combination of load and RPM within the engine's range of operation.

24. A method for operating an oxygen-enriched ammonia-fueled spark ignition engine, comprising the steps of:
fueling the engine with a substantially stoichiometric mixture of auxiliary oxygen and ammonia within a first engine load range between zero and an engine load associated with a target combustion condition selected from the group consisting of rough limit, MBT knock limit, and any of various conditions between the rough limit and MET knock limit, wherein the amounts of auxiliary oxygen and ammonia fueling the engine increase as the load increases within the first engine load range; and
fueling the engine on a substantially stoichiometric mixture of ammonia, auxiliary oxygen and air within a second engine load range between the engine load associated with the selected target combustion condition and the maximum load of the engine, wherein the amounts of ammonia and air fueling the engine increase and the amount of auxiliary oxygen fueling the engine remains substantially constant as the load increases within the second engine load range.

25. The method of claim 24, wherein the target combustion condition comprises the rough limit, and wherein the rough limit is reached at a predetermined engine load that increases as the RPM of the engine increases, and wherein the rough limit corresponds to an auxiliary oxygen input per cycle that increases as the engine RPM increases.

26. The method of claim 24, wherein the target combustion condition comprises the rough limit, and wherein when operating in the second engine load range, the auxiliary oxygen input per cycle is set to a constant value which is sufficient for the highest RPM within the engine's range of operation, and wherein this constant auxiliary oxygen input per cycle is also sufficient for all other RPM within the engine's range of operation.

27. The method of claim 24, wherein the spark ignition engine further comprises an exhaust catalytic converter and at least one exhaust gas oxygen sensor coupled to the exhaust system, and wherein the ammonia input per cycle is determined at least partially by the state of the catalytic converter as sensed by a post-catalyst exhaust gas oxygen sensor, and wherein inclusion of the state of the catalytic converter in the ammonia input calculation, improves the post-catalyst emissions cleanup when auxiliary oxygen is used to promote the combustion of ammonia as the only fuel.

28. The method of claim 24, wherein the rough limit corresponds to a coefficient of variation of a gross indicated mean effective pressure of the engine of about 3%.
